(19) United States
(12) Patent Application Publication
(10) Pub. No.: US 2006/0157671 A1
(43) Pub. Date: Jul. 20, 2006

(54) Slurry for use in metal-chemical mechanical polishing and preparation method thereof

(75) Inventors: Jin-Goo Park, Gyeonggi-do (KR); Young-Jae Kang, Busan (KR); Jae-Hoon Song, Gyeonggi-do (KR); Jung-Soo Jang, Chungcheongbuk-do (KR); Suk-Jo Jung, Daegu (KR); Jung-Hwan Byeon, Nam-gu Daegu (KR); Cheol-Jin Park, Gyeongsanbuk-do (KR); Seon-Yun Bae, Nam-gu Daegu (KR); Moon-Sung Kim, Busan (KR)

Correspondence Address: BLANK ROME LLP, 600 NEW HAMPSHIRE AVENUE, N.W., WASHINGTON, DC, 20037, US

(73) Assignee: ACE HIGHTECH CO., LTD., Gyeonggi-do (KR)

(21) Appl. No.: 11/326,369

(22) Filed: Jan. 6, 2006

Related U.S. Application Data
(63) Continuation-in-part of application No. PCT/KR05/00191, filed on Jan. 14, 2005.

(30) Foreign Application Priority Data
Jan. 14, 2005 (KR) 10-2004-0098016

(51) Int. Cl. C09K 13/00

(52) U.S. Cl. 252/79.1

(57) ABSTRACT

The present invention relates to a slurry for use in metal chemical-mechanical polishing (CMP) and a preparation method thereof. More particularly, the invention relates to a slurry for use in metal CMP, in which iron ions or divalent or higher valent metal ions are physico-chemically adsorbed on colloidal silica particles in the form of particles by a reduction, hydrolysis, impregnation or precipitation method, as well as a preparation method thereof. The slurry useful for metal CMP prepared according to the present invention has a uniform particle size distribution, and shows increased efficiencies as an oxidation catalyst and polishing slurry chemically adsorbed with metal particles, as compared to the prior metal CMP slurry distributed with metal ions. Also, the inventive slurry has long-term storage stability, since it does not show coagulation and precipitation phenomena even after it is stored for more than one year without a dispersant or a dispersion stabilizer. Furthermore, the prior fumed silica contains a large amount of environment-harmful substances for distribution stabilization, such as surfactants and amine compounds, whereas the inventive colloidal silica contains no environment-harmful substances as described above, and thus, is eco-friendly.

### TECHNICAL FIELD

The present invention relates to a slurry for use in metal chemical-mechanical polishing (hereinafter, referred to as “CMP”) and a preparation method thereof. More particularly, the present invention relates to a colloidal silica-based slurry for use in metal CMP, and a preparation method thereof.

### BACKGROUND ART

Generally, in the prior mechanical polishing process for semiconductor processing, deformed layers are caused which act as defects on semiconductor chips, and in the prior chemical polishing process, the deformed layers are not caused, but planarized configuration, i.e., shape precision, cannot be obtained and only smooth surfaces can be merely obtained. It is the fundamental concept of CMP to polish objects using the combined advantages of the two polishing processes.

For semiconductor CMP, slurry is frequently used. In practice, slurry which is a processing solution formed by suspending silica in an aqueous potassium hydroxide solution with pH 10-11 on a polishing pad of polyurethane is fed to polish semiconductor wafers. Such slurry used in the CMP process of semiconductor wafers contains metal oxides, deionized water, additives and the like. As metal oxides, silica (SiO₂), alumina (Al₂O₃), ceria (CeO₂), zirconia (ZrO₂) and the like are mainly used, and the silica (SiO₂) is divided into fumed silica and colloidal silica according to a preparation method thereof.

Known patents relating to slurries containing fumed silica are as follows: U.S. Pat. No. 5,116,535 relating to an aqueous colloidal dispersion of fumed silica containing no stabilizer; U.S. Pat. No. 5,527,423 relating to a method for polishing a tungsten layer using fumed silica slurry; U.S. Pat. No. 6,533,832 relating to an aqueous chemical mechanical fumed silica polishing slurry useful for polishing the polysilicon layer of a semiconductor wafer; and U.S. Pat. No. 6,068,787 relating to a fumed silica slurry for use in removing metal layers from a substrate. However, the fumed silica-based slurries used in the above-mentioned patents are prepared by adding an acid, such as hydrochloric acid, nitric acid or sulfuric acid, to purified water, to make an acidic solution, dispersing fumed silica in the acidic solution, adding a dispersant or a dispersion stabilizer to the solution, and then adding an iron nitrate solution as a catalyzing agent to the dispersion. Also, the fumed silica is not round in particle shape and has a sharp surface, so that, if it is used as it is, it will cause a severe scratch phenomenon on wafers. Thus, in order to prevent the scratch phenomenon from occurring in semiconductor polishing, a polymer compound such as polyacrylamide should be added so as to surround the silica particle surface, and then, hydrogen peroxide should be added to the fumed silica prior to the use of the fumed silica as a polisher in semiconductor processing. As described above, to the fumed silica, many kinds of additives, such as dispersants and stabilizers, should be added during the preparation process thereof.

The fumed silica as described above is known to contain little or no metal impurities other than silica since it is prepared by a burning process comprising burning silicon tetrachloride with water or CO₂ gas at very high temperature so as to make silica particles. However, the fumed silica has problems in that, in the preparation thereof, much heat energy is needed, and also after the preparation thereof, sieving should be carried out so as to make the particle size distribution thereof uniform. Furthermore, the fumed silica has a disadvantage in that it has very low particle size uniformity and a significantly reduced stability upon its dispersion in solution, so that a dispersant and a dispersion stabilizer must necessarily be added, thus making the preparation process inconvenient.

In attempts to improve the above-mentioned problems with the use of the fumed silica, U.S. Pat. No. 6,527,818 discloses an aqueous dispersion with an excellent balance between chemical etching and mechanical polishing performance, comprising colloidal silica. Also, Korean Patent Laid-Open Publication No. 2004-95615 discloses fine colloidal particles for CMP, comprising one or two more oxides. However, the colloidal silica-based slurries used in these patents are advantageous in that the colloidal silica is uniform in spherical particle size and stable in solution, but the slurries have a problem in that they can contain a large amount of impurities depending on the selection of raw materials or preparation methods.

Accordingly, in an attempt to solve the above-described problems, the present inventors have previously filed a patent application (Korean Patent Laid-Open Publication No. 2004-62926, published Jul. 9, 2004) relating to a colloidal silica slurry for semiconductor polishing, which has an increased removal rate over the prior slurries, shows uniform particle size distribution even in large particles, and is far superior in the maintenance of stability in solution to the fumed silica, as well as a preparation method thereof.

### DISCLOSURE OF INVENTION

### Technical Problem

The present invention has been made in order to solve the above problems occurring in the prior art, and it is an object of the invention to provide a slurry for use in tungsten CMP, in which colloidal silica formed in a suspension is not contaminated with metal compounds since it is prepared by an ion exchange method using a sodium silicate solution such that a large amount of the metal contaminants contained in the sodium silicate solution are removed, and also in that the formed particles are uniform in size and has very high stability even when a dispersant or a dispersion stabilizer is not added, as well as a preparation method thereof.

Namely, unlike the prior preparation method, the tungsten CMP slurry containing the colloidal silica, developed by the present inventors, is prepared without the addition of acids to purified water, and contains no dispersant like a surfactant since the colloidal silica itself has very stable dispersibility. Also, the formed colloidal silica particles themselves are round in shape and have a smooth surface, so that they do not cause a scratch phenomenon upon wafer polishing. This eliminates a need for the addition of a polymer compound, such as polyacrylamide, for surrounding the silica particle surface (i.e., coating the silica particle surface).

Another object of the present invention is to provide a tungsten CMP slurry suitable for polishing the tungsten layer of a semiconductor wafer, in which colloidal silica contained in the slurry has an uniform particle size of 10-70 nm by controlling the feed rate, reaction temperature and reaction time of silicic acid, as well as a preparation method thereof.

### Technical Solution

To achieve the above objects, the present invention provides a slurry for use in tungsten CMP, in which iron ions or divalent or higher valent metal ions are physico-chemically adsorbed on colloidal silica particles in the form of particles by a reduction, hydrolysis, impregnation or precipitation method.

In the inventive slurry, the concentration of the colloidal silica particles in the slurry is 3 to 30% by weight. If the silica particle concentration is less than 3% by weight, tungsten removal rate upon the polishing of a semiconductor wafer will be rapidly reduced, and if it exceeds 30% by weight, the removal rate required in a semiconductor wafer polishing process will become excessive, a scratch phenomenon will occur, and particles remaining on the wafer surface after wafer polishing will be increased.

Moreover, the amount of iron ions or divalent or higher valent metal ions adsorbed on the colloidal silica particles is 0.0001-0.1% by weight based on the total weight of the slurry. If the amount of the adsorbed metal ions is less than 0.0001% by weight, their role as an oxidizing agent for tungsten oxidation in semiconductor wafer polishing will be extremely insignificant, and if it exceeds 0.1% by weight, the excessive oxidation and corrosion of the wafer surface in semiconductor wafer polishing will occur.

As used herein, the term “divalent or higher valent metal ions” refers to transition metals including iron.

Furthermore, adsorbing the iron ions or divalent or higher valent metal ions to the silica particles while converting the metal ions into the form of metal particles is conducted by a conventional reduction method. Moreover, the ion adsorption may also be conducted by one method selected from conventional hydrolysis, precipitation and impregnation methods.

### Advantageous Effects

The slurry for use in tungsten CMP prepared according to the present invention has a uniform particle size distribution, and shows increased efficiencies as an oxidation catalyst and polishing slurry chemically adsorbed with metal particles, as compared to the prior tungsten CMP slurry distributed with metal ions. Also, the inventive slurry has long-term storage stability, since it does not show coagulation and precipitation phenomena even after it is stored for more than one year without a dispersant or a dispersion stabilizer. Furthermore, the prior fumed silica contains a large amount of environment-harmful substances for distribution stabilization, such as surfactants and amine compounds, whereas the inventive colloidal silica contains no environment-harmful substances as described above, and thus, is eco-friendly.

### DESCRIPTION OF DRAWINGS

Further objects and advantages of the invention can be more fully understood from the following detailed description taken in conjunction with the accompanying drawings, in which:

FIG. 1 is a flow chart illustrating a preparation method of a slurry for use in tungsten chemical-mechanical polishing according to the present invention; and

FIGS. 2 to 4 depict TEM photographs showing that metal particles are adsorbed on colloidal silica particles according to the present invention; and

FIG. 5 is a graph showing polishing efficiency of iron particles and iron ions according to the present invention; and

FIG. 6 shows decomposition of hydrogen peroxide by iron particles and iron ions according to the present invention; and

FIG. 7 shows UV absorption of iron particles and iron ions according to the present invention; and; and

FIGS. 8 to 9 are photographs showing oxidation of iron particles and iron ions upon addition of hydrogen peroxide according to the present invention.

### MODE FOR INVENTION

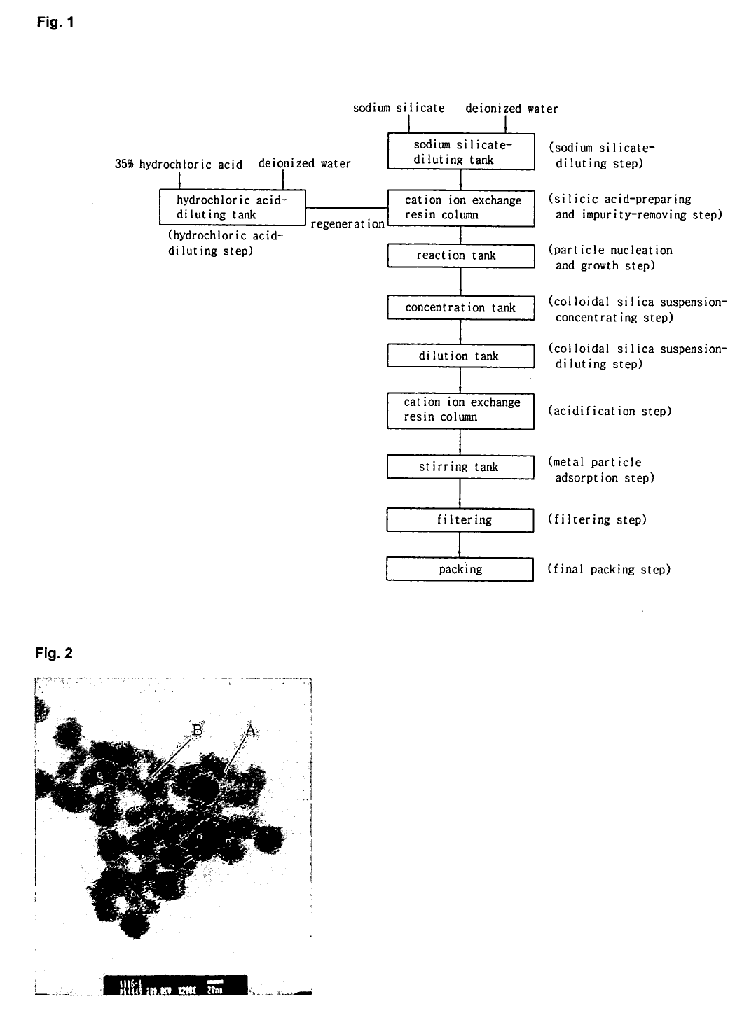

The method for preparing the slurry for use in tungsten CMP according to the present invention will hereinafter be described in detail with reference to the accompanying drawings. FIG. 1 is a flow chart illustrating the preparation method of the slurry useful for tungsten chemical-mechanical polishing according to the present invention.

As shown in FIG. 1, the inventive method for preparing the slurry for use in tungsten CMP comprises the steps of:

i) mixing 5-10% by weight of sodium silicate with 90-95% by weight of deionized water in a sodium silicate-diluting tank so as to obtain an aqueous sodium silicate solution (sodium silicate-diluting step);

ii) diluting 20-30% by weight of 35% hydrochloric acid with 70-80% by weight of deionized water in a separate hydrochloric acid-diluting tank (hydrochloric acid-diluting step);

iii) regenerating cation exchange resin with the diluted aqueous hydrochloric acid solution prepared in the step ii) and washing the regenerated resin with water (cation exchange resin-regenerating step);

iv) passing the diluted aqueous sodium silicate solution prepared in the step i) through the cation exchange resin column regenerated in the step iii) so as to prepare active silicic acid in the form of an oligomer and to remove impurities (silicic acid-preparing and impurity-removing step);

v) transferring the oligomeric silicic acid into a reaction tank at a rate of 50-200 l/hr, adding potassium hydroxide to the silicic acid solution in an amount of 1-20% by weight based on the weight of the silicic acid solution, and allowing the mixture to react at a temperature of 80-200° C. for 0.5-6 hours while forming the nuclei of colloidal silica particles and growing the nuclei into particles (particle nucleation and growth step);

vi) cooling the suspension of the grown colloidal silica particles to ambient temperature and then concentrating the cooled suspension using a concentration membrane in a concentration tank to a colloidal silica concentration of 5-40% by weight (colloidal silica suspension-concentrating step);

vii) diluting the concentrated colloidal silica suspension with deionized water in a dilution tank to a colloidal silica concentration of 5-10% by weight (colloidal silica suspension-diluting step);

viii) transferring the diluted colloidal silica suspension from a storage tank to a cation exchange resin column and passing the transferred suspension through the resin column, so as to acidify the suspension to pH 1-4 (acidification step);

ix) adding a iron salt solution to the colloidal silica suspension in a stirring tank in an amount of 0.0001-0.1% by weight based on the weight of the colloidal silica suspension so as to adsorb the metal particles to the colloidal silica particles (metal particle adsorption step); and

x) filtering the resulting colloidal silica slurry (filtering step).

In the step ii), the amount of hydrochloric acid is preferably 20-30% by weight. If the amount of hydrochloric acid is less than 20% by weight, the regeneration of the cation exchange resin will not be achieved, so that the silicic acid produced by passing the sodium silicate through the ion exchange resin will exceed pH 4 and become a gel state. If the amount of hydrochloric acid exceeds 30% by weight, the amount of hydrochloric acid remaining in the cation exchange resin will be too large, so that the silicic acid produced by the passage of sodium silicate through the cation exchange resin column will have a too low pH of less than 1 due to the remaining hydrochloric acid. Thus, in the subsequent step (i.e., particle production step), the particle production will not be sufficiently achieved due to excessive chlorine, and a coagulation phenomenon will occur.

In the steps iii) to iv), the diluted aqueous hydrochloric acid solution regenerates the cation resin, and the hydrochloric acid solution from the regeneration process is purified in a water treatment step. The cation resin is regenerated by the ion exchange between the hydrogen ion (H⁺) of the hydrochloric acid and the sodium ion (Na⁺) of the cation resin. In the regeneration process of the cation resin, ions (H⁺ and Na⁺) remaining after the ion substitution are removed clean in a water washing process, and water used in the water washing process is purified in a separate water treatment process. Also, impurities (such as metal compounds) contained in the diluted aqueous sodium silicate solution passing through the regenerated cation resin column are removed by the cation exchange resin.

In the step iv), silicic acid in the form of an oligomer is produced and impurities are removed. Also, the nuclei of colloidal silica particles in the state of silicic acid are formed to a size of less than 3 nm.

In the step v), potassium hydroxide is added as a base for colloidal silica particle nucleation, growth and stabilization by a condensation reaction with the oligomeric active silicic acid formed in the step iv). The amount of addition of the potassium hydroxide is 1-20% by weight based on the weight of the silicic acid suspension. If the amount of addition of the potassium hydroxide is less than 1% by weight, an excess of the active silicic acid will react with the base so that the colloidal silica particle nucleation and growth can be reduced due to unreacted silicic acid. If it exceeds 20% by weight, the base will be used in an excess amount relative to the active silicic acid so that it can cause a dissolution phenomenon after the colloidal silica particle nucleation and growth and cause the coagulation between the colloidal silica particles, thus deteriorating the stability of the colloidal silica particles. In place of the potassium hydroxide, one selected from ammonia water (NH₄OH), sodium hydroxide (NaOH) and sodium silicate may also be added in the same amount as that of the potassium hydroxide.

And in the step v), the colloidal silica suspension flows in a reaction tank at a rate of 50-200 l/hr based on the capacity of the reaction tank taken as 1 ton. If the flow rate of the colloidal silica suspension is less than 50 l/hr, the coagulation between the silica particles will be increased, thus causing a problem in terms of particle stability. If the flow rate is more than 200 l/hr, a broad particle size distribution ranging from small to large silica particle size will be resulted due to unreacted silica suspension.

The reaction temperature in the step v) is preferably 80-200° C. If the reaction temperature is lower than 80° C., the condensation reaction between the base and the active silicic acid will be remarkably reduced, so that particle growth sufficient for the purpose of the present invention cannot be achieved. If it is higher than 200° C., the coagulation between the silica particles will occur, thus deteriorating the stability of the colloidal silica.

In the step vi), the colloidal silica is preferably concentrated to 5-40% by weight such that it can be diluted according to the consumer demand.

In order to form colloidal silica particles with the desired size, the colloidal silica particles are grown to a size of 10-70 nm. If the particles have too small size, they will have an insignificant effect on mechanical polishing, and if they have too large size, they will have a problem in terms of stability and cause a severe scratch phenomenon upon wafer polishing. If the particle size needs to be further increased, the steps iv), v) and vi) can be repeated two to five times so as to obtain the desired particle size.

In the step vii), the concentration of the colloidal silica is preferably 5-10% by weight. This is because the colloidal silica concentration must be at least 5% by weight since the loss amount of the colloidal silica when passing through the cation exchange resin to make an acidic solution is more than 1-2% by weight. Also, a colloidal silica concentration of more than 10% by weight is undesirable since the loss amount of the colloidal silica when passing through the cation exchange resin to make an acidic solution will be increased with an increase in the colloidal silica concentration. Furthermore, since the exchange capability of the cation exchange resin is significantly reduced after the colloidal silica is passed through the cation exchange resin, it is necessary to control the colloidal silica concentration to the above-described suitable level.

In the step viii), if the pH of the diluted colloidal silica suspension is less than 4, problems in either the stability of the colloidal silica itself or metal ion adsorption will not be caused, but if the pH is more than 4, the stability of the colloidal silica itself will be reduced and the ability of the colloidal silica to adsorb the metal ions will be insufficient.

In the step ix), if the amount of the metal ions adsorbed on the colloidal silica is less than 0.0001% by weight, the role of the metal ions as a tungsten-oxidizing agent in semiconductor wafer polishing will be extremely insignificant, thus showing a very low tungsten removal rate. If it exceeds 0.1% by weight, the coagulation between the silica particles will be increased to deteriorate the stability of the polishing slurry and to reduce the uniformity of a polished wafer surface upon semiconductor wafer polishing. Also, upon semiconductor wafer polishing, the excessive oxidation and corrosion of the wafer surface will be caused.

In place of the iron salts, one selected from divalent or higher valent metal salts, including ferric nitrate (Fe(NO₃)₃) and ferric chloride (FeCl₃), may be dissolved and added to the colloidal silica particles in the stirring tank.

### Best Mode

The method for preparing the slurry for use in tungsten CMP will now be described in detail by the following examples.

### EXAMPLES 1 TO 3

10% by weight of sodium silicate was dissolved in 90% by weight of deionized water to prepare a sodium silicate dilution. Separately, 20% by weight of 35% hydrochloric acid solution was diluted in 80% by weight of deionized water, and then a cation exchange resin column was regenerated with the diluted aqueous hydrochloric solution. Then, the sodium silicate dilution prepared as described above was passed through the regenerated cation exchange resin column so as to remove impurities contained in the sodium silicate dilution and to form ologomeric active silicic acid with a size of less than 3 nm. The prepared active silicic acid was transferred into a reaction tank at a flow rate of 100 l/hr based on 1 ton of the reaction tank, and allowed to react at a temperature of 120±5° C. for 3 hours so as to grow colloidal silica particles. Then, colloidal silica suspension was concentrated with a concentration membrane until the concentration of the colloidal silica reached 20% by weight. The concentrated colloidal silica suspension was diluted again to 6% by weight and passed from a storage tank through the cation resin column so as to acidify the colloidal silica suspension to pH 2. Then, to the colloidal silica suspension in a stirring tank, iron was added in an amount of 0.005% by weight based on the weight of the colloidal silica suspension so as to adsorb the iron particles onto the colloidal silica particles. Next, filtering was performed. Prior to use in a semiconductor process, 3% by weight of hydrogen peroxide was added to the resulting slurry, and three samples were collected.

### COMPARATIVE EXAMPLES 1 TO 3

At very high temperature, silicon tetrachloride (SiCl₄) was burned with water or CO₂ gas so as to prepare fumed silica particles. The fumed silica particles were sieved, and to purified water, an acid, such as hydrochloric acid, nitric acid or sulfuric acid, was added so as to acidify the solution to about pH 2. Then, 5-6% by weight of the fumed silica particles were dispersed in the acidic solution to which less than 0.1% by weight of a dispersant or a dispersion stabilizer was then added. Then, 0.0064% by weight of a ferric nitrate (Fe(NO₃)₃) solution as a catalyzing agent was added. The fumed silica is not round in shape and has a sharp surface so that if it is used as it is, it will cause a severe scratch phenomenon. Thus, in order to prevent the scratch phenomenon from occurring in semiconductor wafer polishing, a polymer compound such as polyacrylamide was added so as to surround the surface of the fumed silica particles. Prior to use in a semiconductor process, 3% by weight of hydrogen peroxide was added to the resulting slurry, and then three samples were collected.

(Test Conditions)

CMP apparatus: Ebara FREX-200 R-side manufactured by Ebara Co., Japan;

Polishing pad: IC1400 (Rodel Co., USA);

Object to be polished: 8-inch wafer on which tungsten has been deposited to a thickness of 10,000-12,000 Å;

Revolution speed of surface plate: 31 rpm;

Revolution speed of carrier: 95 rpm;

Feed rate of polishing slurry: 200 ml/min; and

Pressure (main air): 200 hpa.

Under the above test conditions, the samples were measured for removal rate, defects and non-uniformity, and the measurement results are given in Table 1 below.

TABLE 1

| | Examples | | | Comparative Examples | | |
|---|---|---|---|---|---|---|
| | 1 | 2 | 3 | 1 | 2 | 3 |
| Removal | 4,220 | 4,250 | 4,260 | 3,730 | 3,710 | 3,770 |
| rate (Å) | | | | | | |
| Defects | 114 | 132 | 108 | 152 | 233 | 189 |
| (number) | | | | | | |
| Non-uni- | 2.3 | 2.2 | 2.2 | 1.2 | 1.2 | 1.2 |
| formity (%) | | | | | | |

From Table 1 above, it can be found that Examples 1-3 had a higher removal rate than that of Comparative Examples 1-3, and were smaller in the defect number of semiconductor wafers after polishing since the colloidal silica was smoother than the fumed silica. Also, Examples 1-3 showed an improved non-uniformity as compared to Comparative Examples 1-3. Furthermore, FIGS. 2 to 4 show the results of transmission electron microscope (TEM) analysis for Examples 1-3. As shown in FIGS. 2 to 4, the colloidal particles had a size of 40-70 nm, and iron metal particles B were adsorbed on the surface of the colloidal silica particles A.

Meanwhile, the slurry according to the present invention contains iron in the particle phase whereas iron is in the ion state according to the method using fumed silica. The roles of the particulate iron and the ion-state iron are described, with reference to the attached drawings.

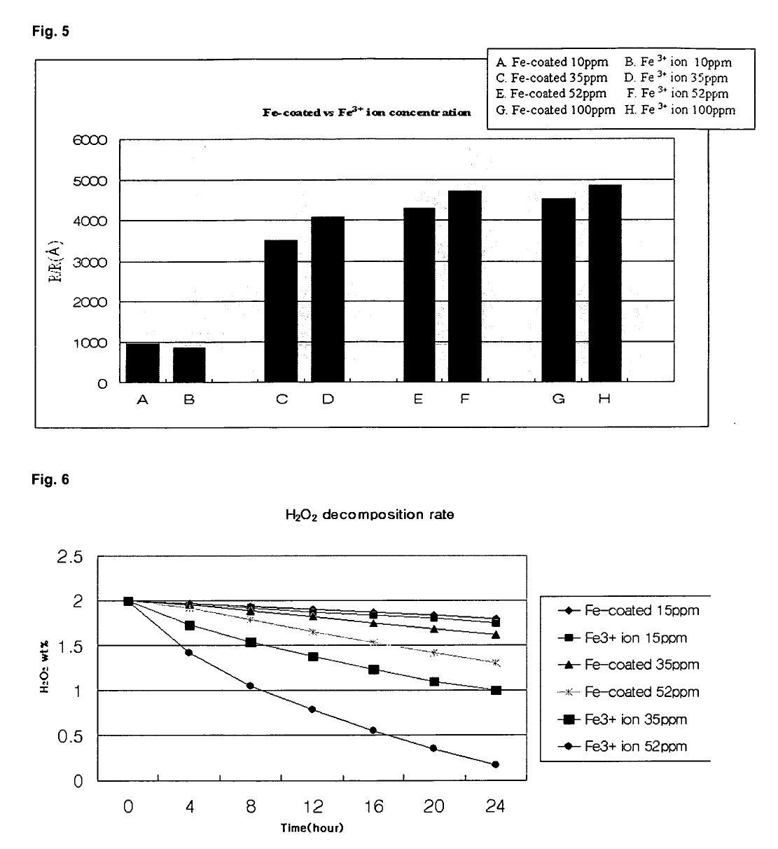

FIG. 5 is a graph showing polishing efficiency of iron particles and iron ions, in which A, C, E and G represent polishing efficiencies at various iron particle contents (10 ppm, 35 ppm, 52 ppm and 100 ppm) and B, D, F and H represent polishing efficiencies at various iron ion contents (10 ppm, 35 ppm, 52 ppm and 100 ppm). The polishing rates of the iron particles and the iron ions were different from each other. When iron existed in the ionic state, the polishing rate was much higher than what was required in the production process and thus, it was nessary to use an inhibitor to slow down the polishing rate. However, when iron existed as particles according to the present invention, the polishing rate was enough to be suitable for the production spot, without need of any further additive.

FIG. 6 shows decomposition of hydrogen peroxide by iron particles and iron ions. The iron ions more rapidly decomposed hydrogen peroxide than the iron particles. If the hydrogen peroxide decomposition rate was too fast, the polishing could not be performed smoothly.

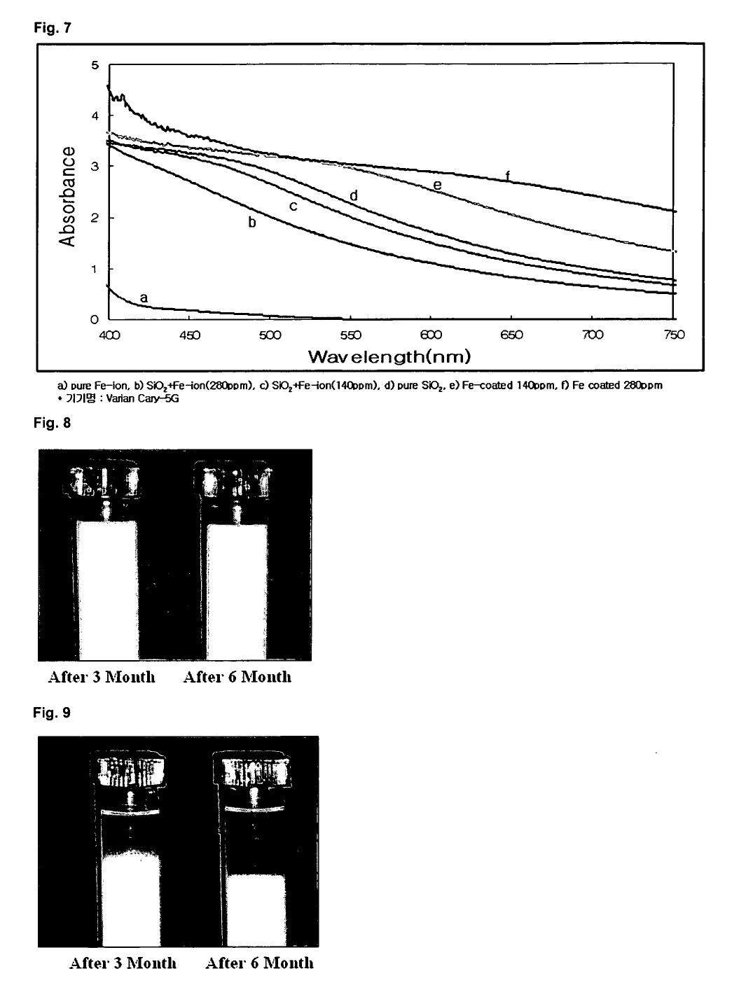

FIG. 7 shows UV absorption of iron particles and iron ions, in which a represents pure iron ions, b represents a composite of silica and iron ions at 280 ppm, c represents a composit of silica and iron ions at 140 ppm, d represents silica, e represents silica coated with iron at 140 ppm and f represents silica coated with iron at 280 ppm. The UV absorption of the iron ions was different from that of the iron particles.

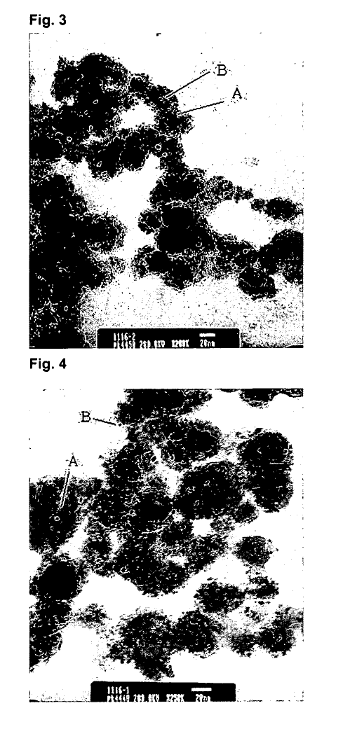

FIG. 8 and FIG. 9 are photographs showing oxidation of iron particles and iron ions upon addition of hydrogen peroxide. As shown in FIG. 3d, when iron existed as particles, there was no change between before and after the addition of hydrogen peroxide. However, when iron existed as ions, as shown in FIG. 3e, there was color change after the addition of hydrogen peroxide as compared to before the addition of hydrogen peroxide, since iron was oxidized by the added hydrogen peroxide to form iron particles.

As described above, the polishing rate, hydrogen peroxide decomposition, UV absorption and oxidation were all different between the iron particles and the iron ions. Particularly, when iron existed as particles, any further additive was not needed.

### INDUSTRIAL APPLICABILITY

As described above, the slurry for use in tungsten CMP prepared according to the present invention has a uniform particle size distribution, and shows increased efficiencies as an oxidation catalyst and polishing slurry physico-chemically adsorbed with metal particles, as compared to the prior tungsten CMP slurry distributed with metal ions. Also, the inventive slurry has long-term storage stability, since it does not show coagulation and precipitation phenomena even after it is stored for more than one year without a dispersant or a dispersion stabilizer. Furthermore, the prior fumed silica contains a large amount of environment-harmful substances for distribution stabilization, such as surfactants and amine compounds, whereas the inventive colloidal silica contains no environment-harmful substances as described above, and thus, is eco-friendly.

While the present invention has been described with reference to the particular illustrative embodiments, it is not to be restricted by the embodiments but only by the appended claims. It is to be appreciated that those sterilized in the art can change or modify the embodiments without departing from the scope and spirit of the present invention.

1. A slurry for use in tungsten CMP comprising iron or metal particles adsorbed on colloidal silica particles, in which the iron or metal particles are formed by converting iron ions or divalent or higher valent metal ions into the form of particles by reduction, characterized in that divalent or higher valent metal ions are transition metals including iron, the colloidal silica particles are present at a concentration of 3 to 30% by weight, based on the total weight of the slurry, and the iron or metal particles are adsorbed on the colloidal silica particles in an amount of 0.0001 to 0.1% by weight, based on the total weight of the slurry.

2. The slurry of claim 1, wherein the iron or metal particles are formed by one method selected from hydrolysis, precipitation and impregnation.

3. The slurry of claim 1, wherein the colloidal silica particles have a particle size of 10 to 70 nm.

4. A method for preparing a slurry for use in tungsten-CMP, the method comprising the steps of:
i) mixing 5 to 10% by weight of sodium silicate with 90 to 95% by weight of deionized water in a sodium silicate-diluting tank to obtain an aqueous sodium silicate solution (sodium silicate-diluting step);
ii) diluting 20 to 30% by weight of 35% hydrochloric acid with 70 to 80% by weight of deionized water in a separate hydrochloric acid-diluting tank (hydrochloric acid-diluting step);
iii) regenerating cation exchange resin with the diluted aqueous hydrochloric acid solution prepared in the step ii) and washing the regenerated resin with water (cation exchange resin-regenerating step);
iv) passing the diluted aqueous sodium silicate solution prepared in the step i) through the cation exchange resin column regenerated in the step iii) to prepare active silicic acid in the form of an oligomer and to remove impurities (silicic acid-preparing and impurity-removing step);
v) transferring the oligomeric silicic acid into a reaction tank at a rate of 50 to 200 l/hr, adding potassium hydroxide to the silicic acid solution in an amount of 1 to 20% by weight based on the weight of the silicic acid solution, allowing the mixture to react at a temperature of 80 to 200° C. for 0.5 to 6 hours to form the nuclei of colloidal silica particles which are grown into particles (particle nucleation and growth step);
vi) cooling the suspension of the grown colloidal silica particles to ambient temperature and then concentrating the cooled suspension using a concentration membrane in a concentration tank to a colloidal silica concentration of 5 to 40% by weight (colloidal silica suspension-concentrating step);
vii) diluting the concentrated colloidal silica suspension with deionized water in a dilution tank to a colloidal silica concentration of 5 to 10% by weight (colloidal silica suspension-diluting step);
viii) transferring the diluted colloidal silica suspension from a storage tank to a cation exchange resin column and passing the transferred suspension through the resin column, so as to acidify the suspension to pH 1 to 4 (acidification step);
ix) adding a iron salt solution to the colloidal silica suspension in a stirring tank in an amount of 0.0001 to 0.1% by weight based on the weight of the colloidal silica suspension so as to adsorb the metal particles to the colloidal silica particles (metal particle adsorption step); and
x) filtering the resulting colloidal silica slurry (filtering step).

5. The method of claim 4, wherein, in the step ix), one selected from ferric nitrate (Fe(NO₃)₃) and ferric chloride (FeCl₃) in place of the iron salts is dissolved and added to the colloidal silica suspension.
